(19) United States
(12) Patent Application Publication
(10) Pub. No.: US 2017/0152824 A1
(43) Pub. Date: Jun. 1, 2017

(54) FUEL PUMP

(71) Applicant: Hitachi, Litd, Tokyo (JP)

(72) Inventors: Nikhil Seera, Farmington Hills, MI (US); Akira Inoue, Farmington Hills, MI (US)

(21) Appl. No.: 14/955,851

(22) Filed: Dec. 1, 2015

(51) Int. Cl. F02M 59/46; F02M 59/02; F04B 53/10; F04B 53/14; F04B 19/22; F04B 53/16

(52) U.S. Cl. CPC F02M 59/466; F04B 19/22; F04B 53/16; F04B 53/10; F04B 53/14; F02M 59/025

(57) ABSTRACT

A pump having a housing defining a pump chamber, an inlet, and an inlet passageway fluidly connecting the inlet to the pump chamber. A solenoid actuated inlet valve is disposed in series with the inlet passageway and movable between an open position and a closed position. A core is mounted to the housing while an anchor is aligned along an axis with the core in the housing. The anchor mechanically contacts the valve member so that the anchor displaces the valve member between its open and closed position as the anchor moves between a first and a second position. The facing ends of the anchor and core are shaped so that only a portion of the area of those ends come in contact with each other when the solenoid is energized and the anchor is in its second position thereby reducing the impact sound.

### BACKGROUND OF THE INVENTION

I. Field of the Invention

The present invention relates generally to sound reduction for a solenoid actuated mechanical component and, more particularly, to a fuel pump for an automotive vehicle.

II. Description of Related Art

The development of direct injection internal combustion engines is a key technology in the automotive industry in its quest to meet stringent CAFE (Corporate Average Fuel Economy) standards. Unlike the port fuel injection internal combustion engines where the gasoline or fuel is first sprayed into an intake manifold, in a direct injection engine gasoline is sprayed at high pressures directly into the combustion chamber of the engine.

This direct injection of the fuel charge into the combustion chamber enables the direct injection engine to achieve high volumetric efficiency, lean air-fuel mixture, and complete combustion, all of which results in better fuel economy for the vehicle.

In order to achieve the desired operation for the direct injection internal combustion engine, it is necessary to provide high pressure fuel to the fuel injectors sufficient to overcome the pressure of the combustion chamber. As such, the development of high pressure fuel pumps for direct injection engines forms a critical component for the overall fuel system.

Most fuel pumps for direct injection engines include a pump housing having a fuel inlet connected to the fuel tank and a fuel outlet connected to a fuel rail. The fuel rail in turn is fluidly connected to the fuel injectors.

The pump housing includes a pump or pressure chamber which is fluidly connected by an inlet passageway to the fuel inlet to the pump housing. Similarly, an outlet chamber fluidly connects the pump chamber to the fuel rail, typically through a one-way check valve.

An inlet valve assembly is mounted fluidly in series with the inlet passageway. The inlet valve assembly is typically solenoid actuated with the duration and timing of the solenoid controlled by the electronic control unit (ECU) for the engine. Actuation of the solenoid thus moves a valve member of the valve assembly between its open position, in which the fuel tank is fluidly connected to the pump chamber, and a closed position, in which the fuel tank is fluidly disconnected from the pump chamber.

In order to provide the high pressure fuel from the fuel pump, a plunger open to the pump chamber is reciprocally driven by the vehicle engine. In operation when the plunger is moved in a suction stroke away from the pump chamber, the inlet valve assembly is opened thus allowing fuel to be inducted from the fuel tank and into the pump chamber. Conversely, during the compression cycle of the plunger, the inlet valve assembly is closed so that the compression stroke of the plunger forces the now pressurized fuel through an outlet check valve and into the fuel rail.

The inlet fuel valve assembly for these previously known fuel pups conventionally includes an inlet valve member which is fluidly disposed in series with the inlet passageway. A generally cylindrical core of the valve assembly is mounted to the pump housing while a generally cylindrical anchor is axially slidably mounted in the housing in alignment with the core and so that one end of the anchor faces the core. A rod is then attached to the anchor at one end and at its other end is aligned with the inlet valve member.

Consequently, upon deenergization and energization of the solenoid, the solenoid axially displaces the anchor with its attached rod which, in turn, opens and closes the valve member. In operation, the facing ends of the anchor and core are spaced apart from each other at a first position when the solenoid is deenergized. Conversely, when the solenoid is energized these facing ends of the anchor and the core contact each other or vice versa.

One disadvantage of the previously known direct injection engines, and particularly of the fuel pump, is that the fuel pumps are noisy, especially at low or idle speeds. The source of this noise arises from tour metal-to-metal impacts which take place as the solenoid actuates the inlet valve between its open and its closed position. There are other sources such as gasoline flow induced sound and pressure pulsation sound.

First, the metal contact between the anchor and the core when the solenoid is energized forms the dominant sound source for the fuel pump. This relatively large sound source arising from the metal contact between the anchor and core is caused, in large part, since the entire facing ends of the anchor and core contact each other during each opening and closure of the inlet valve. This relatively large area of contact thus creates a large sound source which is audible especially at low engine speeds.

The secondary sound sources include the contact between the inlet valve and its valve seat, the rod and the inlet valve, and the inlet valve and the valve stopper. These three metal contacts, however, contribute less to the sound from the fuel pump than the anchor-core contact.

### SUMMARY OF THE PRESENT INVENTION

The present invention provides a fuel pump which overcomes the above-mentioned disadvantages of the previously known fuel pumps.

Like the previously known fuel pumps, the fuel pump of the present invention includes a housing which defines a pump chamber. A fluid inlet which is fluidly connected to a source of fuel, e.g. the fuel tank, is fluidly connected by an inlet passageway to the pump chamber. Similarly, an outlet passageway is fluidly coupled to an outlet from the pump. A one-way check valve is provided in the outlet passageway to prevent backflow of fuel from the fuel rail into the pump chamber.

An inlet valve is fluidly disposed in series at a midpoint of the inlet passageway. The inlet valve is solenoid actuated. As such, a core is mounted to the housing while an anchor is slidably mounted in the housing in axial alignment with the core. This anchor is attached to a rod aligned with the inlet valve. Consequently, actuation of the solenoid causes the anchor to axially reciprocate which, in turn, opens and closes the inlet valve.

Unlike the previously known fuel pumps, however, in the present invention the facing ends of the core and anchor are shaped so that only a portion of the area of the ends come into contact with each other upon actuation or deactuation of the solenoid. Consequently, by reducing the area of contact between the core and the anchor, the sound generated by the metal-to-metal contact between the core and anchor is reduced.

The actual shape of the ends of the anchor and core may assume many different forms. However, in one embodiment, the facing ends of the anchor and core are separated into a plurality of arc sections which alternate between raised sections and depressed sections. The sections on the anchor are complementary to the sections on the core so that the depressed sections on the anchor receive the raised sections on the core and vice versa. These sections of the anchor and core, furthermore, are designed so that only a limited number of the arc sections actually contact each other during actuation of the inlet valve. The limited number of arc sections which contact each other during the valve actuation thus effectively reduces the area of contact between the anchor and the core thereby reducing the sound of the impact.

Alternatively, the facing ends of the anchor and core are formed at different radiuses of curvature. The different radiuses of curvature effectively space the facing ends apart from each other upon contact except for a limited area. These different radiuses of curvature initially result in a line/edge contact instead of a face-to-face contact. Upon usage the line/edge contact may wear to a limited area contact.

Optionally, the facing ends of the anchor and core include sliding surfaces which generate friction during the actuation of the inlet valve. These sliding surfaces effectively dissipate the impact energy of the core and anchor thus reducing the fuel pump noise.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a sectional view illustrating a fuel pump of the present invention;

FIG. 2 is a sectional view illustrating the inlet valve assembly;

FIG. 3 is an elevational view illustrating an exemplary core;

FIG. 4 is an elevational view illustrating an exemplary anchor;

FIG. 5 is a view similar to FIG. 3, but illustrating a modification thereof;

FIG. 6 is a side view of the core and anchor when in a contacting position;

FIG. 7 is an elevational view similar to FIG. 6, but illustrating a modification thereof; and

FIG. 8 is a view of box FIG. 8 in FIG. 7 and enlarged for clarity.

### DETAILED DESCRIPTION OF PREFERRED EMBODIMENTS OF THE PRESENT INVENTION

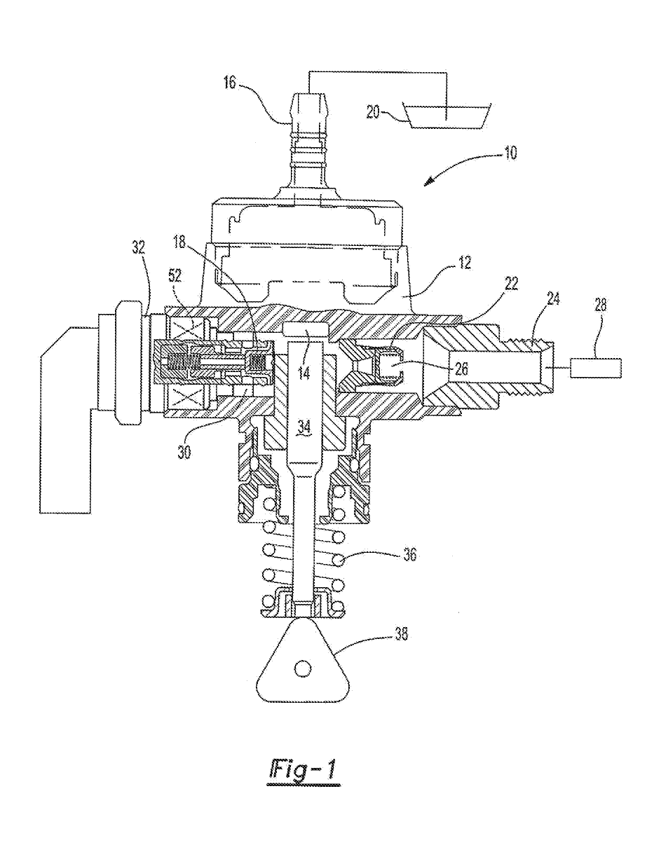

With reference first to FIG. 1, a fuel pump 10 according to the present invention is shown. While the fuel pump 10 is particularly suitable for use in a direct injection automotive vehicle, the pump 10 may be used in other applications without deviation from the spirit or scope of the invention.

The pump 10 includes a housing 12 which defines a pump chamber 14. The pump chamber 14 is fluidly connected to a fuel inlet 16 by an inlet passageway 18. The fuel inlet 16, in turn, is connected to a source 20 of fuel, such as the fuel tank.

Still referring to FIG. 1, an outlet passageway 22 fluidly connects the pump chamber 14 to a fuel outlet 24. A one-way check valve 26 is disposed in series with the outlet passageway 22 to prevent backflow into the pump chamber 14. The pump outlet 24 in turn is connected to a fuel rail 28.

A fuel inlet valve assembly 30, which will be subsequently described in greater detail, is disposed in series with the inlet passageway 18. The inlet valve assembly 30 is actuated by a solenoid 32 to actuate the valve assembly between an open and a closed position. In its open position, the valve assembly 30 establishes fluid communication from the inlet 16 to the pump chamber 14. Conversely, in its closed position, the inlet 16 is fluidly isolated from the pump chamber 14.

In order to pressurize the fuel, a plunger 34 is slidably mounted to the housing 12 and is aligned with and open to the pump chamber 14. A compression spring 36 urges the plunger 34 outwardly from the pump chamber 14. However, the plunger 34 is reciprocally driven by a cam 38 rotatably driven by the engine so that the plunger 34 reciprocates relative to the pump chamber 14.

Consequently, in operation, as the plunger 34 is in its suction cycle in which the plunger 34 is moving away from the pump chamber 14, the inlet valve assembly 34 is open thus allowing fuel to be inducted from the fuel inlet into the pump chamber 14. Conversely, as the plunger 34 moves in its compression stroke, i.e. toward the pump chamber 14, the valve assembly 30 is closed so that the pressurization of the fuel in the pump chamber 14 caused by the plunger 34 is pumped through the one-way check valve 26 and to the fuel rail 28. Since the cam 38 is driven by the engine, the speed of the reciprocation of the plunger 34 varies directly as a function of the engine speed.

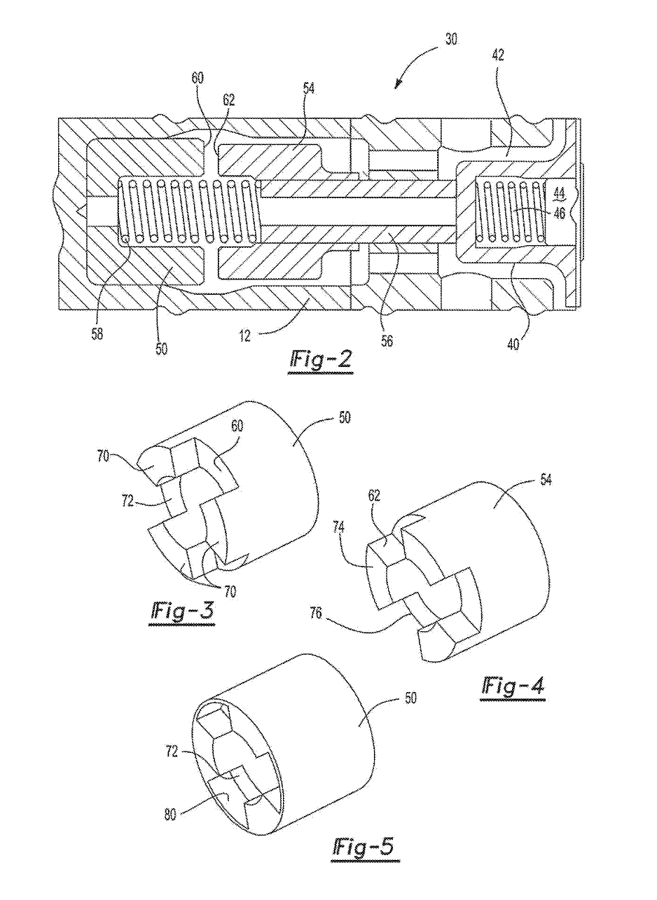

With reference now to FIG. 2, the inlet valve assembly 30 is shown in greater detail. The inlet valve assembly 30 includes a valve member 40 which cooperates with a valve seat 42 which forms a port in series with the inlet passageway 18. Consequently, with the valve member 40 in contact with the valve seat 42, fluid flow through the inlet passageway 18 is prevented. Conversely, when the valve member 40 is moved away from its valve seat 42, the port is open thus enabling fluid flow through the inlet passageway 18.

The axial displacement of the valve member 40 is limited in a first axial direction by the valve seat 42. Conversely, a valve stopper 44 limits the axial travel of the valve member 40 in the opposite axial direction, i.e. when in its open position. Furthermore, a compression spring 46 is entrapped between the valve stopper 44 and the valve member 40 which urges the valve member 40 towards the valve seat 42.

A magnetic core 50 is mounted to the housing 12 in axial alignment with the valve member 40. A solenoid coil 52 is disposed around the core 50 so that, upon actuation, the core 50 forms a part of the magnetic circuit for the coil 52.

An anchor 54 and its attached rod 56 are mounted in between the core 50 and the valve member 40. The anchor is made of a ferromagnetic material and forms a part of the magnetic circuit for the solenoid coil 52. Furthermore, a compression spring 58 urges the anchor 54 and its attached rod 56 towards the valve member 40. The inlet valve assembly 30 is normally open. Upon actuation of the solenoid coil 52, the anchor 54 is drawn towards the core 50 and so that the facing ends 60 and 62 of the core 50 and anchor 54, respectively, contact each other. In doing so, the anchor 54 retracts the rod 56 from the valve member 40 thus allowing the valve member 40 to shift to its closed position due to the force of the compression spring 44. Conversely, upon deactivation of the solenoid coil 52, the compression spring 58 times the anchor 54 and rod 56 towards the valve member 40 thus compressing the spring 46 and moving the valve member 46 to its open position. For a normally closed valve, the valve member 60 and its port would be redesigned and the opening and closing of the valve member 40 caused by actuation of the solenoid coil 52 is reversed.

In order to reduce the noise of the fuel pump, the facing ends 60 and 62 of the core 50 and anchor 54, respectively, are shaped so that the area of contact between the ends 60 and 62 upon actuation of the solenoid coil 52 is reduced. By reducing the area of contact between the core end 60 and the anchor end 62, noise is effectively reduced.

With reference then to FIGS. 3 and 4, the core end 60 is preferably provided with alternating raised arc sections 70 and depressed arc sections 72. As shown in FIG. 3, the core end 60 includes three raised sections 70 as well as three depressed sections 72. However, this is by way of example only, and more or fewer raised sections 70 and depressed sections 72 may be employed without deviation from the spirit or scope of the invention.

With reference now to FIG. 4, the anchor 54 includes raised arc sections 74 and depressed arc sections 76 that are substantially the same in shape and size as the sections 70 and 72 on the core. The arc sections 74 and 76 on the anchor 54 are complementary to the arc sections 70 and 72 on the core 50 so that each raised section 74 on the anchor 54 is aligned with and received within a corresponding depressed arc section 72 on the core 50. Likewise, each raised section 70 on the core 50 is aligned with and received within a corresponding depressed arc section 76 on the anchor 54. Thus, as shown in FIG. 4, when the solenoid coil 52 is actuated, the raised and depressed arc sections on both the core 50 and anchor 54 intermesh with each other.

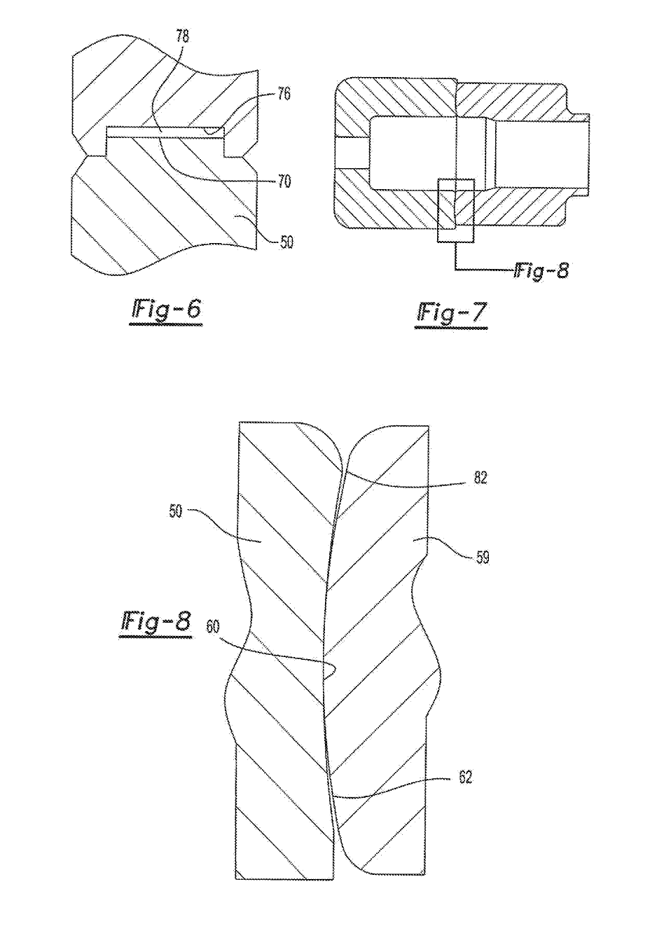

Referring now particularly to FIG. 6, the axial length of the raised arc segment 70 or 74 on the core 50 or anchor 54, respectively, is shorter than the axial depth of the corresponding depressed arc section 76 or 72 on the anchor 54 or core, respectively. As such, when the solenoid 52 is actuated and the core 50 and anchor 54 come into contact with each other as shown in FIG. 6, a gap 78 is formed between the raised arc segments 70 or 74 and their corresponding aligned depressed arc segments 72 and 76.

Consequently, assuming that each arc segment 70-76 is of the same arcuate length, when the ends 60 and 62 of the core 50 and anchor 54 come into contact with each other, the area of contact between the core 50 and the anchor 54 is effectively reduced by one half. This, in turn, reduces the sound from the fuel pump 10.

With reference now to FIG. 5, in a modification of the present invention an outer annular wall 80 is formed around each depressed arc section 72 in the care 50. These outer wails 80 are dimensioned so that a frictional contact is maintained in between the raised arcuate segments 74 on the anchor 54. This frictional contact, furthermore, generates heat thus consuming energy and reducing the noise from the fuel pump. Furthermore, the walls 80 may alternatively be formed on the anchor 54.

With reference now to FIG. 7, a still further design is shown for reducing the area of contact between the core 50 and the anchor 54. As shown in, rather than forming the ends 60 and 62 of the core 50 and anchor 54 as flat surfaces, the ends 60 and 62 of the core 50 and anchor 54 are formed at two different radiuses of curvature so that one end 60 is concave while the other end 62 is convex or vice versa.

Alternatively, the different radii of FIG. 8 can be combined with the alternating rises and recesses of FIGS. 3 and 4.

Since the ends 60 and 62 of the core 50 acid anchor 54 are formed at different radiuses of curvature, a gap 82 is formed between the core end 60 and anchor end 62 thereby reducing the area of contact between the core 50 and anchor 54.

The contact between the core 50 and anchor 54 will cause some flattening of the core 50 and/or anchor 54 at the point of contact. However, reduction in the area of contact will be inherently accomplished and that reduction is due in large part to the magnitude of the difference between the radiuses of curvature of the ends 60 and 62 of the core 50 and anchor 54, respectively.

It will be understood, of course, that the foregoing examples to reduce the area of contact between the core 50 and anchor 54 are by way of example only. Many of the shapes, indeed an unlimited number of different shapes, may alternatively be used to reduce the area of contact without deviation from the spirit or scope of this invention.

Having described our invention, however, many modifications thereto will become apparent to those skilled in the art to which it pertains without deviation from the spirit of the invention as defined by the scope of the appended claims.

We claim:

1. A pump comprising:
a housing having a pump chamber, an inlet and an inlet passageway fluidly connecting said inlet to said pump chamber,
an inlet valve disposed in series with said inlet passageway, said valve movable between an open position and a closed position,
a core mounted to said housing,
an anchor aligned along an axis with said core in said housing, said anchor mechanically contacting said valve member so that said anchor displaces said valve member between said open and closed positions as said anchor axially moves between a first position in which an end of said anchor and an end of said core are spaced apart from each other and a second position in which said anchor and said core contact each other,
wherein said ends of said anchor and said core are shaped so that only a portion of the area of said ends come in contact with each other when said anchor is in said second position.

2. The pump as defined in claim 1 wherein said ends of said anchor and core have complementary recesses and rises and wherein only a portion of said recesses and rises contact each other when said anchor is in said second position.

3. The pump as defined in claim 2 wherein said recesses and rises are teeth shaped.

4. The pump as defined in claim 1 wherein said ends of said anchor and core are formed at different curvatures.

5. The pump as defined in claim 1 and comprising a first axially extending wall portion on one of said core and said anchor and a second axially extending all portion on the other of said core and said anchor, said first and second wall portions being in sliding contact with each other as said core moves between said first and said second positions.

6. The pump as defined in claim 1 wherein said core and said anchor are substantially cylindrical in cross-sectional shape and wherein said ends of said core and said anchor are divided into complementary alternating arcuate raised sections and depressed sections.

7. The pump as defined in claim 6 wherein only a portion of said sections on said core contact said anchor when said anchor is in said second position.

8. The pump as defined in claim 1 and comprising an elongated rod attached to said anchor at one end and facing said valve member at its other end.

9. The pump as defined in claim 8 and comprising a first compression spring which urges said rod towards said valve member and a second compression spring which urges said valve member towards said rod.
